(19) United States
(12) Patent Application Publication
(10) Pub. No.: US 2017/0300480 A1
(43) Pub. Date: Oct. 19, 2017

(54) TRANSFERRING DATA FROM A FIRST DATA ENVIRONMENT TO A SECOND DATA ENVIRONMENT

(71) Applicant: GE Aviation Systems LLC, Grand Rapids, MI (US)

(72) Inventors: Hatice Mujde AYIK, Istanbul (TR); Peter Robin KNIGHT, Eastleigh (GB)

(21) Appl. No.: 15/486,962

(22) Filed: Apr. 13, 2017

(30) Foreign Application Priority Data
Apr. 14, 2016 (GB) 1606530.2

(51) Int. Cl. G06F 17/30

(52) U.S. Cl. CPC G06F 17/303

(57) ABSTRACT

Systems and methods for transferring data from a first data environment to a second data environment are disclosed. In particular, data can be obtained from a first data environment. One or more user inputs can be received specifying parameters to be associated with a second data environment. A plurality of table structures can be generated, each having a format determined in accordance with the one or more parameters. The obtained data from the first data environment can be mapped to the plurality of table structures. The plurality of table structures can then be mapped to the second data environment based at least in part on the one or more user inputs.

### FIELD

The present subject matter relates generally to transferring data and more particularly to transferring data from a first data environment to a second data environment.

### BACKGROUND

Data analysis can be an important technique for evaluating the performance and/or efficiencies of various systems. For instance, data associated with one or more aircraft systems or other systems can be obtained from the system and transferred to a data environment suitable for analysis. Such analytical data environments can include structured, manipulated, and/or formatted representations of data suitable for analysis.

Conventional techniques for transferring data from a first data environment to a second data environment (e.g. analytical data environment) can require manual intervention in providing suitable data representations. For instance, a user may be required to specify one or more parameters for each representation of data in one or more analytical data environments. Such conventional techniques can be time-consuming, inaccurate, and/or inefficient.

### BRIEF DESCRIPTION

Embodiments of the present disclosure will be set forth in part in the following description, or may be learned from the description, or may be learned through practice of the embodiments.

One example embodiment of the present disclosure is directed to a computer-implemented method of transferring data from a first data environment to a second data environment. The method includes obtaining, by one or more computing devices, data from a first data environment. The method further includes receiving, by the one or more computing devices, one or more user inputs specifying one or more parameters to be associated with a second data environment. The method further includes generating, by the one or more computing devices, a plurality of table structures. Each table structure has a format determined in accordance with the one or more parameters. The method further includes mapping, by the one or more computing devices, the obtained data from the first data environment to the plurality of table structures. The method further includes writing, by the one or more computing devices, the plurality of table structures to the second data environment based at least in part on the one or more user inputs.

Another example aspect of the present disclosure is directed to a computing system. The computing system includes one or more processors and one or more memory devices. The one or more memory devices store computer-readable instructions that when executed by the one or more processors cause the one or more processors to perform operations. The operations include obtaining data from a first data environment, receiving one or more user inputs specifying one or more parameters to be associated with a second data environment, generating a plurality of table structures having a format determined in accordance with the one or more parameters, mapping the obtained data from the first data environment to the plurality of table structures, and writing the plurality of table structures to the second data environment based at least in part on the one or more user inputs.

Yet another example aspect of the present disclosure is directed to one or more tangible, non-transitory computer-readable media storing computer-readable instructions that when executed by one or more processors cause the one or more processors to perform operations. The operations include obtaining data from a first data environment, receiving one or more user inputs specifying one or more parameters to be associated with a second data environment, generating a plurality of table structures having a format determined in accordance with the one or more parameters, mapping the obtained data from the first data environment to the plurality of table structures, and writing the plurality of table structures to the second data environment based at least in part on the one or more user inputs.

Variations and modifications can be made to these example aspects of the present disclosure.

Various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for transferring data from a first data environment to a second data environment according to example embodiments of the present disclosure;

FIGS. 2A and 2B depict example representations of data in a second data environment according to example embodiments of the present disclosure; and

FIG. 3 depicts a method of transferring data from a first data environment to a second data environment according to example embodiments of the present disclosure.

### DETAILED DESCRIPTION

Reference now will be made in detail to embodiments of the invention, one or more examples of which are illustrated in the drawings. Each example is provided by way of explanation of the present invention, not limitation of the present invention. In fact, it will be apparent to those skilled in the art that various modifications and variations can be made in the present invention without departing from the scope or spirit of the present invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to transferring data from a first data environment to a second data environment. For instance, data can be obtained from a first data environment and mapped to one or more data frameworks in a second environment. The one or more data frameworks can be generated based at least in part on one or more user inputs specifying one or more parameters to be associated with the second data environment. The one or more data frameworks can then be written to the second data environment based at least in part on the parameters specified by the user inputs.

More particularly, the first data environment can be a data processing environment. In some implementations, the data can be associated with an aircraft engine or other aircraft component. It will be appreciated that various other suitable data can be used without deviating from the scope of the present disclosure, such as for instance, sales figures, inventory reports, test scores, weather reports, etc. The second data environment can be a spreadsheet environment or other environment configured to manipulate and/or display at least a portion of the data in an organized manner. For instance, the data framework(s) can be table structures generated in accordance with the one or more user inputs.

The one or more user inputs can specify formatting parameters, function parameters, and/or other parameters to be associated with the data framework(s). In some implementations, the parameters can be initialized to a default parameter set. In this manner, the user specified parameters can include one or more deviations from the default parameter set. In some implementations, the one or more formatting parameters can include one or more label parameters, header parameters, title parameters, number format parameters, border parameters, and/or other parameters to be associated with the data framework(s). In this manner, the user can specify the location and dimensionality of the data framework(s) within the second data environment, as well as various textual data to be displayed in association with the data framework(s).

The one or more function parameters can specify various functions to be applied to at least a portion of the data. In addition, the function parameters can specify one or more additional columns and/or rows to be added to the data framework(s) wherein the results of the applied functions can be displayed. For instance, such functions can include one or more summing functions, averaging functions, or various other functions associated with the manipulation of at least a portion of the data.

In some implementations, the user can further specify the data to be displayed within the data framework(s) in the second data environment. For instance, the user can specify a data file or other representation of data to be displayed within the data framework(s). In some implementations, data framework(s) can be formatted based at least in part on the specified data. For instance, in implementations wherein the data framework(s) are table structures, the dimensionality (e.g. number of rows and/or columns) of the table structures can be determined based at least in part on the amount of data stored in the specified data file.

In some implementations, the user can further specify the data environment to which the data should be mapped. In particular, the user can specify a file or other location to which the data should be written. In implementations wherein the second data environment is a spreadsheet environment, the user can specify a particular “worksheet” within a file wherein the data is to be written. In some implementations, the user can further specify a location within the “worksheet” wherein the data framework is to be located. In some implementations, multiple data frameworks can be written to the same file location. For instance, a particular “worksheet” in a spreadsheet environment may contain multiple table structures generated in accordance with example embodiments of the present disclosure. Once the data is written to the specified environment, the data can be provided for display in a user interface associated with the second data environment. In some implementations, one or more data plots or diagrams may be generated and provided for display based at least in part on the data and the one or more user inputs.

In implementations wherein multiple data frameworks are generated, the user can specify parameters to be associated with each framework. For instance, the user may specify a first set of parameters to be associated with a first data framework and a second set of parameters to be associated with a second data framework. In some implementations, the user may specify one or more universal parameters to be applied to each data framework. In this manner, multiple data frameworks can be generated for multiple data sets based on a single set of user specified parameters.

In some implementations, the generated data frameworks can have associated boundary indicators specifying one or more locations associated with a boundary of the data framework. For instance, a data framework can have an associated column boundary indicator specifying the column where the data framework ends within the data environment. As another example, the data framework can have an associated row boundary indicator specifying the row where the data framework ends within the data environment. In some implementations, the boundary indicators can be provided for display to the user such that the user can easily identify the location of the data framework. The user can then use the boundary indicators to position a subsequent data framework. In some implementations, the boundary indicators can be used to automatically position one or more subsequent data frameworks. In particular, one or more locations can be determined for each data framework based at least in part on the boundary indicators. For instance, the location(s) can be relative to the boundary indicators of a previous data framework. The data frameworks can then be automatically positioned in the determined locations.

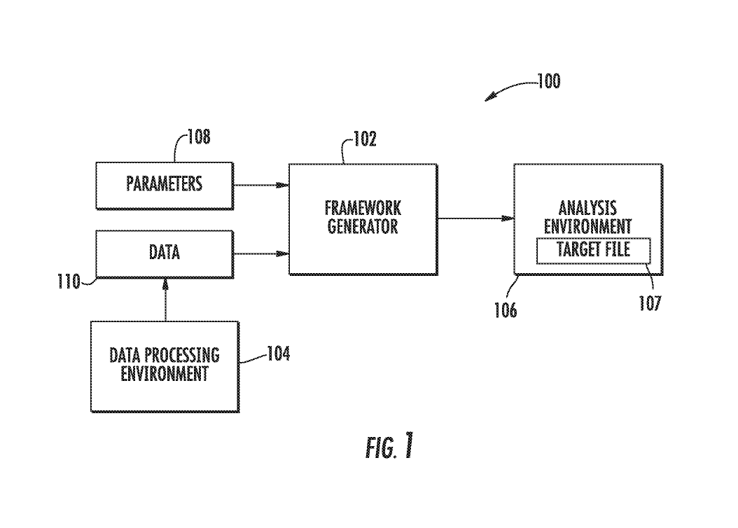

Referring now to the figures, example embodiments of the present disclosure will be discussed in greater detail. For instance, FIG. 1 depicts an overview of an example system 100 for transferring data from a first data environment to a second data environment according to example embodiments of the present disclosure. In particular, system 100 includes a framework generator 102, a data processing environment 104 and an analysis environment 106. Framework generator 102 can be configured to receive parameters 108 and data 110 as input and to generate one or more data frameworks based at least in part on parameters 108 and data 110.

In particular, parameters 108 can be specified by one or more user inputs. For instance, a user or operator of a system 100 can input into a user interface associated with system 100 one or more parameters in accordance with which one or more data frameworks should be generated. As indicated above, parameters 108 may include one or more parameters associated with labels, titles, number format, color format, target file, etc. Parameters 108 may further include instructions to “freeze” one or more cells within the spreadsheet environment, and/or one or more instructions to open or close the spreadsheet environment. Parameters 108 may further include one or more conditional formatting operations to be applied to one or more cells in the data frameworks. Parameters 108 may further specify one or more functions to be applied to at least a portion of data 110. For instance, parameters 108 may include one or more summing functions, averaging functions, and/or other functions, and the data to which such functions should be applied. In addition, parameters 108 may specify one or more locations wherein the results of such functions should be displayed.

Data 110 can be obtained from data processing environment 104. As indicated above, data processing environment 104 and/or data 110 can be associated with one or more aircraft components, such as an aircraft engine. In particular, data processing environment 104 can be any environment that includes one or more sets of data that can be processed or otherwise manipulated. Data 110 can include at least a portion of data from data processing environment 104. In some implementations, the data 110 to be provided as input to framework generator 102 can be specified by a user, for instance, through a user input associated with a user interface of system 100. In some implementations, data 110 can be automatically identified and/or obtained.

Framework generator 102 can be configured to generate one or more table structures or other data frameworks based at least in part on data 110 and parameters 108, such that the table structures are formatted in accordance with parameters 108. For instance, framework generator 102 can generate a table structure having a title, labels, dimensionality, coloring, font, font size, headers, etc. as specified in parameters 108. Framework generator 102 can be further configured to map data 110 to the data frameworks. For instance, framework generator 110 can be configured to map each instance of data to a particular location within the generated data frameworks. In this manner, framework generator 110 can be configured to generate and format one or more table structures in accordance with parameters 108, and to populate the generated table structures with data 110.

Framework generator 110 can further be configured to provide the populated data frameworks to analysis environment 106. For instance, analysis environment 106 can be a spreadsheet environment associated with system 100. In particular, framework generator 102 can be configured to write the populated data frameworks to one or more target files 107 within analysis environment 106. In some implementations, the one or more target files 107 can be specified by the user as part on parameters 108. In particular, the populated data frameworks can be written to specific locations within the target file 107. For instance, the populated data frameworks can be written to a particular “worksheet” associated with the target file 107, and/or to a particular location within the “worksheet.” For instance, the populated data frameworks can be written to a particular series of cells within a “worksheet” in a spreadsheet environment.

Framework generator 102 can further be configured to output one or more boundary indicators associated with each generated data framework. For instance, the boundary indicators can include one or more locations specifying the one or more boundaries of each data framework within analysis environment 106. In particular, the boundary indicators can include one or more column locations and/or one or more row locations indicating such boundaries. The boundary indicators can be used to determine the ending position of a particular data framework, such that an additional data framework can be added adjacent the data framework.

In some implementations, one or more functions can be applied to at least a portion of data within the populated data frameworks in analysis environment 106. For instance, the functions can be specified as part of parameters 108, and can be implemented within analysis environment 106. As indicated above, the one or more functions can be used to manipulate at least a portion of data within the data frameworks. For instance, the one or more functions can include arithmetic operations or other computations associated with the data.

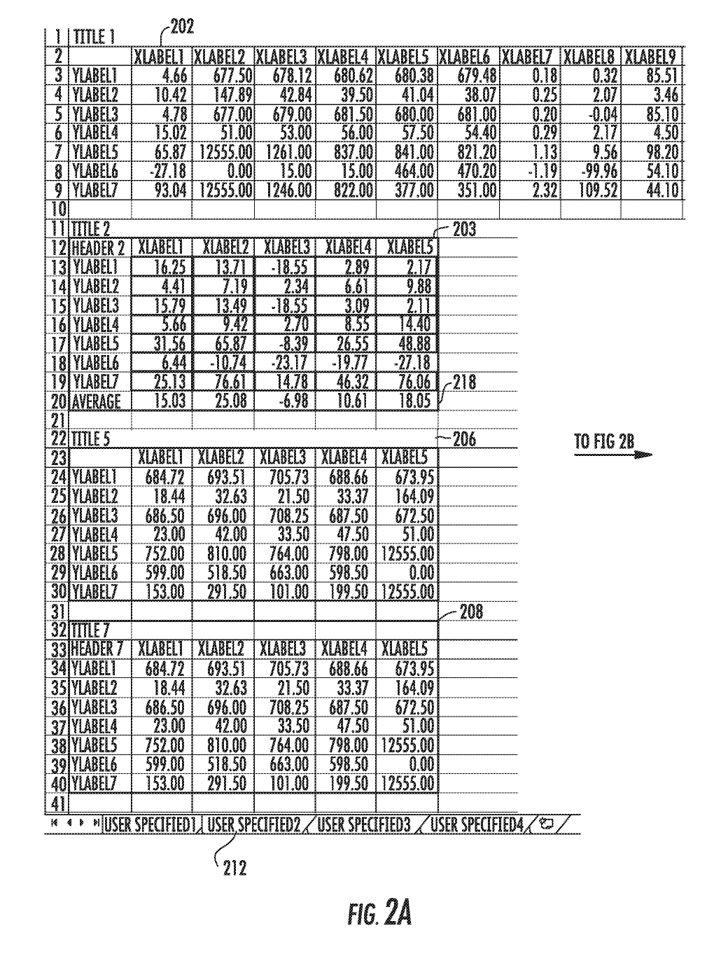

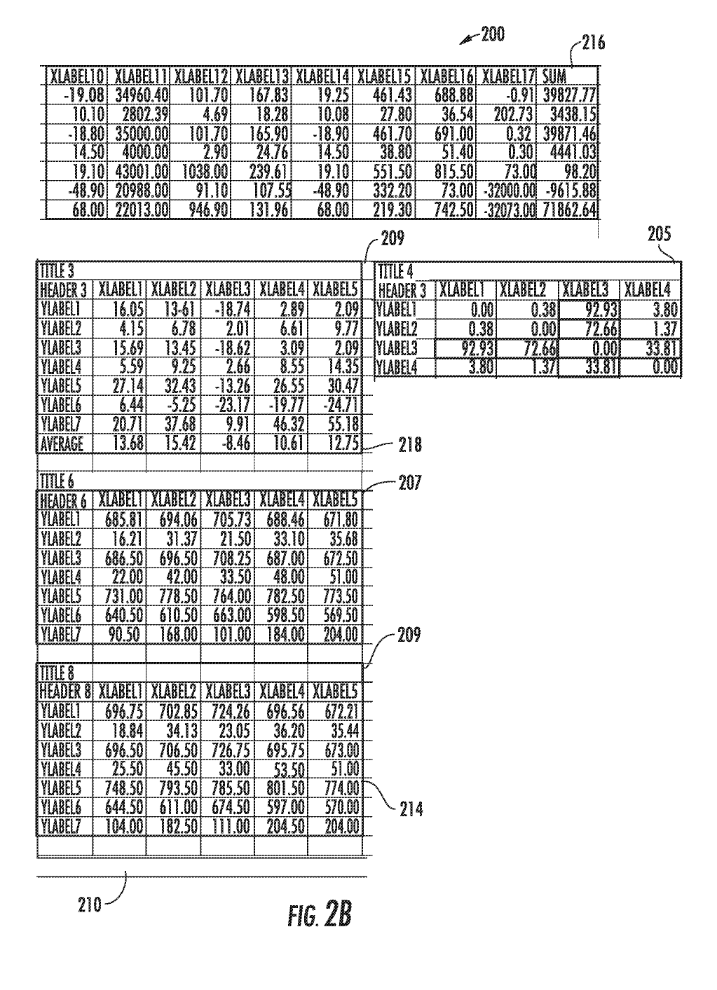

FIGS. 2A and 2B depict an example spreadsheet environment 200 according to example embodiments of the present disclosure. As shown, spreadsheet environment 200 includes data frameworks 202, 203, 204, 205, 206, 207, 208, and 209, and a worksheet tab bar 210. Worksheet tab bar 210 provides user selectable tabs 212 that allow a user to toggle between worksheets in spreadsheet environment 200.

As shown, frameworks 202-209 can include one or more user specified parameters such as a title, a header, x-axis labels (xlabel), and y-axis labels (ylabel). Frameworks 202-209 can further be populated with various data 214. As described above, data 214 can be obtained from a data processing environment and used to populate data frameworks 202-209.

As indicated, the location of the data frameworks 202-209 can be specified by the user. For instance, the user can specify a particular row and/or column from where a data framework is to start. The data framework can then be written to that particular location.

Data frameworks 202-209 can further include function columns/and or function rows. For instance, data framework 202 includes a sum column 216. Sum column 216 can be written to a user specified location within spreadsheet environment 200. In some implementations, the user specified location can be a location relative to data framework 202. As shown, each cell in sum column 216 can include a summation of data located in the corresponding rows in data framework 202. As another example, data frameworks 203 and 204 include averaging rows 218. Each cell in averaging rows 218 can provide an average value of the corresponding columns in data frameworks 203 and 204.

Tab bar 210 includes tabs 212, each corresponding to a different worksheet within spreadsheet environment 200. As indicated above, one or more data frameworks can be written to each worksheet according to example embodiments of the present disclosure. For instance, a user may specify that one or more additional data frameworks are to be written to the worksheet entitled UserSpecified3. Selecting the corresponding tab 212 will cause UserSpecified3 and the one or more additional data frameworks to be displayed.

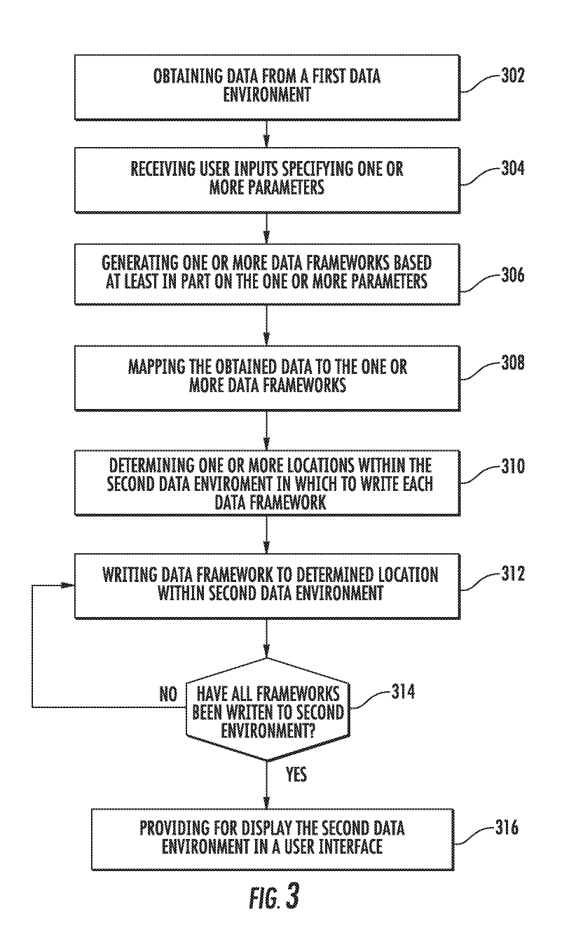

FIG. 3 depicts a flow diagram of an example method (300) of transferring data from a first data environment to a second data environment. Method (300) can be implemented by one or more computing devices, such as one or more of the computing devices depicted in FIG. 1. In addition, FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (302), method (300) can include obtaining data from a first data environment. For instance, the first data environment can be a data processing environment or other environment configured to store data. The data can be any suitable type of data, such as for instance, data associated with an aircraft.

At (304), method (300) can include receiving one or more user inputs specifying one or more parameters to be associated with a second data environment. For instance, the one or more parameters can include formatting parameters, such as parameters relating to a title, labels, color, number formatting, position, dimensionality, headers, conditional formatting operations, etc. of a table structure or other data framework. The parameters can further include one or more function parameters specifying one or more operations to be performed on at least a portion of the data. In some implementations, the function parameters can include instructions to implement one or more functions within the second data environment.

At (306), method (300) can include generating one or more data frameworks. For instance, the data frameworks can be table structures or other frameworks configured to structure data in an organized manner. In particular, the data frameworks can be generated in accordance with the user specified parameters.

At (308), method (300) can include mapping the obtained data to the one or more data frameworks. For instance, each instance of data can be mapped to a location within a data framework. In this manner, the data frameworks can be populated with the obtained data, resulting in one or more populated data frameworks.

At (310), method (300) can include determining one or more locations within the second data environment to which to write each data framework. For instance, as indicated, the user specified parameters can include one or more locations to which to write the data frameworks. In particular, the one or more locations may be specified at least in part by one or more indices or boundaries associated with each data framework specifying an ending location of the framework. It will be appreciated that various other location indicators can be used without deviating fro the scope of the present disclosure.

At (312), method (300) can include writing the one or more data frameworks to the second data environment. As indicated, the second data environment can be a spreadsheet environment or other data environment. In particular, writing the one or more data frameworks to the second data environment can include writing the data frameworks to one or more locations within the second data environment as specified by the parameters input by the user. In particular, a data framework can be written to target file associated with the second data environment. The data framework can be written to a particular location within a particular worksheet within the second data environment. In some implementations, the location to which the data framework is written can be a particular cell wherein the data framework will begin. The location of the cell can be specified by an intersection between a particular row and a particular column.

At (314), method (300) can include determining if all the user specified data frameworks have been written to the appropriate locations within the second data environment. If all of the frameworks have not been written to the second environment, method (300) can return to (312).

If, at (314), all of the data frameworks have been written to the second data environment, at (316), method (300) can include providing for display the second data environment in a user interface. For instance, second data environment can be provided for display by one or more computing devices associated with the user. In some implementations, one or more visual data representations, such as one or more charts, graphs or diagrams can be generated and provided for display as an alternative or in addition to the data frameworks. For instance, such visual data representations can be correspond to data within a particular data framework. In some implementations, the data representations can be positioned adjacent a corresponding data framework, for instance, as specified by the user.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method of transferring data from a first data environment to a second data environment, the method comprising:
obtaining, by one or more computing devices, data from a first data environment;
receiving, by the one or more computing devices, one or more user inputs specifying one or more parameters to be associated with a second data environment;
generating, by the one or more computing devices, a plurality of table structures, each table structure having a format determined in accordance with the one or more parameters;
mapping, by the one or more computing devices, the obtained data from the first data environment to the plurality of table structures; and
writing, by the one or more computing devices, the plurality of table structures to the second data environment based at least in part on the one or more user inputs.

2. The computer-implemented method of claim 1, wherein writing, by the one or more computing devices, the plurality of table structures to the second data environment comprises writing each table structure to one or more locations within the second data environment.

3. The computer-implemented method of claim 1, further comprising determining, by the one or more computing devices, a location within the second data environment for each table structure of the plurality of table structures; and
wherein writing the plurality of table structures to the second data environment comprises writing each table structure to the determined location within the second data environment.

4. The computer-implemented method of claim 3, wherein the plurality of table structures have associated boundary indicators specifying one or more boundaries of the respective table structures within the second data environment.

5. The computer-implemented method of claim 4, wherein determining, by the one or more computing devices, a location within the second data environment for each table structure comprises determining a location within the second data environment for each table structure based at least in part on the respective boundary indicators.

6. The computer-implemented method of claim 4, wherein the boundary indicators comprise a column boundary indicator and a row boundary indicator.

7. The computer-implemented method of claim 1, wherein the first data environment is a data processing environment.

8. The computer-implemented method of claim 1, wherein the data from the first data environment comprises data associated with an aircraft engine.

9. The computer-implemented method of claim 1, wherein at least one of the one or more parameters to be associated with the second data environment specifies one or more formatting parameters to be associated with the second data environment.

10. The computer-implemented method of claim 9, wherein generating, by the one or more computing devices, the plurality of table structures in the second data environment comprises generating the plurality of table structures in accordance with the one or more formatting parameters.

11. The computer-implemented method of claim 9, wherein the one or more formatting parameters comprise one or more label parameters, header parameters, title parameters, number format parameters, or border parameters.

12. The computer-implemented method of claim 1, wherein at least one of the one or more parameters to be associated with the second data environment comprise one or more functions to be applied to at least a portion of the obtained data.

13. The computer-implemented method of claim 1, wherein the second data environment comprises a spreadsheet environment.

14. The computer-implemented method of claim 1, further comprising generating, by the one or more computing device, one or more data plots based at least in part on the obtained data from the first environment and the one or more user inputs.

15. The computer-implemented method of claim 1, further comprising providing for display, by the one or more computing devices, the second data environment in a user interface.

16. A computing system, comprising:
one or more processors; and
one or more memory devices, the one or more memory devices storing computer-readable instructions that when executed by the one or more processors cause the one or more processors to perform operations, the operations comprising:
obtaining data from a first data environment;
receiving one or more user inputs specifying one or more parameters to be associated with a second data environment;
generating a plurality of table structures, each table structure having a format determined in accordance with the one or more parameters;
mapping the obtained data from the first data environment to the plurality of table structures; and
writing the plurality of table structures to the second data environment based at least in part on the one or more user inputs.

17. The computing system of claim 16, wherein at least one of the one or more parameters to be associated with the second data environment specifies one or more formatting parameters to be associated with the second data environment.

18. The computing system of claim 16, wherein writing the plurality of table structures to the second data environment comprises writing each table structure to one or more locations within the second data environment.

19. One or more tangible, non-transitory computer-readable media storing computer-readable instructions that when executed by one or more processors cause the one or more processors to perform operations, the operations comprising:
obtaining data from a first data environment;
receiving one or more user inputs specifying one or more parameters to be associated with a second data environment;
generating a plurality of table structures having a format determined in accordance with the one or more parameters;
mapping the obtained data from the first data environment to the plurality of table structures; and
writing the plurality of table structures to the second data environment based at least in part on the one or more user inputs.

20. The one or more tangible, non-transitory computer-readable media of claim 19, wherein mapping, by the one or more computing devices, the obtained data from the first data environment to the plurality of table structures comprises mapping the obtained data to one or more locations within the plurality of table structures.
